(19) United States
(12) Patent Application Publication
(10) Pub. No.: US 2006/0068827 A1
(43) Pub. Date: Mar. 30, 2006

(54) Measuring power of a pilot channel of a transmit signal

(75) Inventor: Wolfgang Franz Eckl, Spardorf (DE)

Correspondence Address: WILLIAMS, MORGAN & AMERSON, 10333 RICHMOND, SUITE 1100, HOUSTON, TX, 77042, US

(73) Assignee: Lucent Technologies, Inc.

(21) Appl. No.: 10/952,452

(22) Filed: Sep. 28, 2004

(51) Int. Cl. H04B 7/00; H04Q 7/20

(52) U.S. Cl. 455/522

(57) ABSTRACT

The present invention provides a device for measuring a pilot channel output power of a transmitter, such as a base station transmitting spread spectrum signals. For example, the device may include a detector to deliver an analog signal or a digital number that is proportional to a code domain power of a pilot channel. In one embodiment, a signal metric measuring device may use a detector that measures power of a pilot channel of a transmitter associated with a communication node in a wireless network. The detector may obtain an indication that is proportional to the power of the pilot channel of a transmit signal from the transmitter and use that indication of the power of the pilot channel for controlling a control loop in the transmitter. As a result, a desired level of an output power of the communication node, such as a base station (e.g., Node B) in a wireless network, such as a digital cellular network may be maintained. In this manner, an accurate value for the output power may be obtained, avoiding a long time averaging and use of random or pseudorandom data as modulation content.

### BACKGROUND OF THE INVENTION

1. Field of the Invention

This invention relates generally to telecommunications, and more particularly, to wireless communications.

2. Description of the Related Art

Advances in wireless technology have transformed mobile communications, leading to widespread acceptance and use of cellular technology. However, increasing system capacity to meet this increased demand while maintaining a quality of services to users of mobile communications systems with a limited number of radio channels presents a constant challenge. To support a range of voice and data communications, as well as video, in mobile communication systems, a geographic service area may be partitioned into a number of cells. Each cell has a cell site (also called a base station) connected to a wireline network. The cell site establishes a wireless link over radio channels with wireless communication devices, such as mobile devices within the cell. The mobile device users or subscribers of a wireless service, may send and receive information (e.g. text, audio, speech, or video) via a Public Switched Telephone Network (PSTN). As the mobile device users move from one cell to another cell, their communications may be handed-off to a new cell without an interruption in the wireless service.

In Global System for Mobile Communications (GSM) systems, cell size is directly correlated to the output power of a base station. The output power signal of a GSM base station may be measured and controlled using power control loops because the output power signal is a constant envelope signal. That is, the actual output power is independent of the modulation content of the GSM signal.

However, in many Third Generation (3G) mobile communication systems, such as a Universal Mobile Telecommunications System (UMTS), the situation is different. The UMTS uses signals with higher modulation schemes. These signals have non-constant power envelopes. Depending on the modulation content, the actual output power may vary. A measure for this variation is the ratio between the output power peaks and the long time average of the signal power. This peak to average ratio can vary by 10 dB for the UMTS and a Code Division Multiple Access (CDMA) 2000 signals. Additionally, the long time average output power may vary with the amount of traffic in the wireless network. Thus, the average output power when no user traffic is present is much lower than the average output power with substantial user traffic. This effect is called power rise. So the actual and the average output power no longer is an accurate measure for the power setting needed to cover a certain cell size.

To address some of the above described problems while measuring and controlling the output power of a non-constant envelope signal, the gain of the most important stages is kept constant. This is mainly done by taking a fraction of the actual output power and comparing it with a fraction of the actual input power. For this output power measurement, currently different power detectors are used. These power detectors are based on diodes or logarithmic amplifiers.

However, when handling a fast time variant signal like a CDMA or a Wideband-CDMA modulated signal, the measurement of the power of such a signal may be inaccurate due to statistical behavior. To obtain a more reliable value for the output power, a long time averaging in conjunction with use of random or pseudorandom data as modulation content may be used.

The present invention is directed to overcoming, or at least reducing, the effects of, one or more of the problems set forth above.

### SUMMARY OF THE INVENTION

In one embodiment of the present invention, a device may comprise a detector that measures a power of a pilot channel of a transmit signal from a transmitter associated with a communication node in a wireless network. The device may further include a control loop in the transmitter to maintain a desired level of an output power of the communication node based on the power of the pilot channel.

In another embodiment, a method is provided for measuring a power of a pilot channel of a transmitter associated with a communication node in a wireless network. The method comprises obtaining an indication that is proportional to the power of the pilot channel of a transmit signal from the transmitter and controlling a control loop in the transmitter to maintain a desired level of an output power of the communication node based on the indication of the power of the pilot channel.

In yet another embodiment, a telecommunication system may comprise a communication node associated with a wireless network. The communication node may communicate with a mobile device. The communication node may include a transmitter for enabling mobile communications with the mobile device over a wireless medium using a pilot channel. The transmitter may include a detector that may measure a power of the pilot channel of a transmit signal from the transmitter associated with the communication node in the wireless network, such as a digital cellular network. The transmitter may further include a control loop that may maintain a desired level of an output power of the communication node based on the power of the pilot channel.

### BRIEF DESCRIPTION OF THE DRAWINGS

The invention may be understood by reference to the following description taken in conjunction with the accompanying drawings, in which like reference numerals identify like elements, and in which:

FIG. 1 illustrates a detector that measures a channel power of a pilot channel of a transmit signal from a transmitter associated with a communication node in a wireless network according to one illustrative embodiment of the present invention;

FIG. 2 illustrates a non-constant spread spectrum signal from a transmitter, such as a based station transmitter in accordance with one embodiment of the present invention;

FIG. 3 illustrates a stylized representation of a method for measuring a channel power of a pilot channel of a transmitter associated with a communication node in a wireless network consistent with one embodiment of the present invention;

FIG. 4 illustrates a telecommunication system including a communication node associated with a wireless network to communicate with a mobile device, wherein the communication node includes a transmitter for enabling mobile communications with the mobile device over a wireless medium using a pilot channel and the transmitter includes the detector shown in FIG. 1 according to one embodiment of the present invention;

FIG. 5 illustrates a stylized representation of a method for using the channel power of a pilot channel for controlling a control loop in the transmitter shown in FIG. 4 to maintain a desired level of an output power of the communication node in accordance with one illustrative embodiment of the present invention; and

FIG. 6 illustrates a digital cellular network including a plurality of cells in which a cell includes a node base transceiver station comprising the transmitter shown in FIG. 4 to communicate with a mobile device in accordance with one illustrative embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions may be made to achieve the developers' specific goals, such as compliance with system-related and business-related constraints, which may vary from one implementation to another. Moreover, it will be appreciated that such a development effort might be complex and time-consuming, but would nevertheless be a routine undertaking for those of ordinary skill in the art having the benefit of this disclosure.

Generally, a device for measuring pilot channel output power of a transmitter, such as a base transceiver station (BTS) transmitting spread spectrum signals to mobile devices, is provided. The pilot channel output power may be a measure of the BTS range to the mobile devices. The device may include a detector to deliver a power signal, such as an analog signal or a digital number, which is proportional to a code domain power of a pilot channel. This power signal may be used by a control loop to maintain a desired transmitter output power of the BTS. The detector may comprise an analog-to-digital converter, a despreader, a channel selector, a channel power calculator and, depending upon the usage, a digital-to-analog converter. The detector may further comprise a frequency down converter and a memory to store spreading codes and a programming interface to provide and program a despreading code.

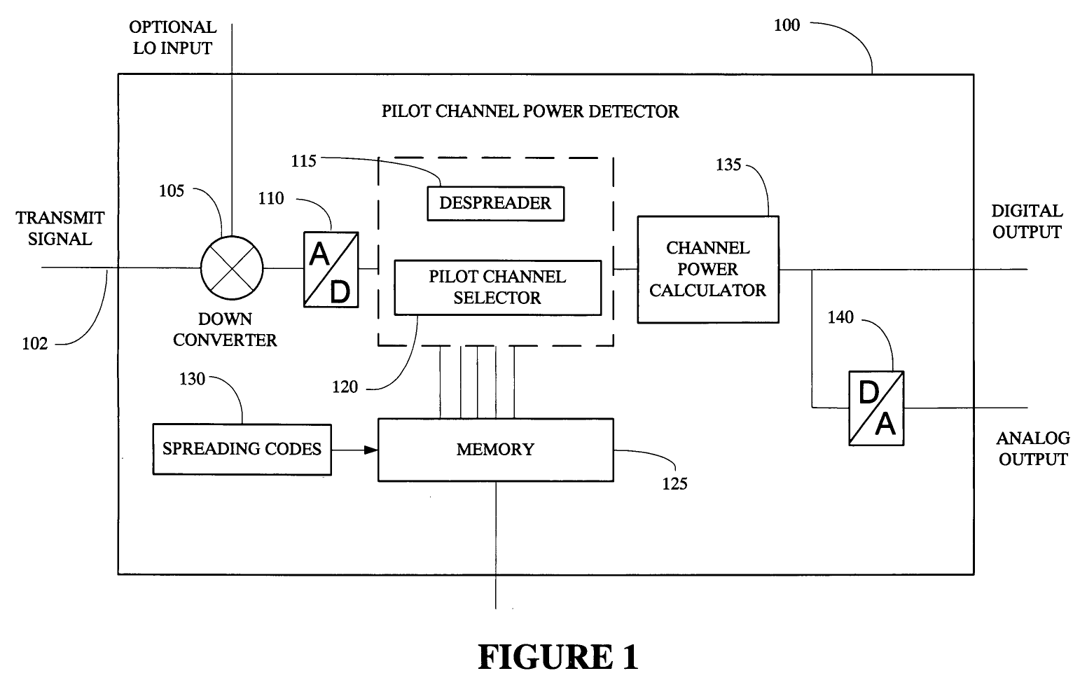

Referring to FIG. 1, a detector 100 is shown to measure a channel power of a pilot channel of a transmit signal 102 from a transmitter (not shown) associated with a communication node in a wireless network according to one illustrative embodiment of the present invention. The detector 100 may comprise a down converter 105, which may receive the transmit signal 102 and convert it into a lower frequency transmit signal. The down converter 105 may receive a local oscillator (LO) input for a radio frequency (RF) mixing process, in one embodiment.

For the detector 100, e.g., when used in a CDMA wireless mobile communication system, a pilot channel may be a special channel that a BTS transmits constantly or regularly. The pilot channel may be transmitted using Walsh code channel 0, which is all 0's, and using a bit pattern of all 0's, containing a short code at the phase being used by the BTS. A system acquisition by a mobile device, such as a cell phone typically may begin by locating the pilot channel, which may permit the cell phone to synchronize its short code with the BTS. Specifically, the pilot channel may be an unmodulated, direct-sequence spread spectrum signal transmitted continuously by a CDMA base station. This pilot channel may allow a mobile device to acquire the timing of a forward CDMA channel, providing a phase reference for coherent demodulation, and providing a means for signal strength comparisons between the base stations for determining when to handoff a call.

The detector 100 may further comprise an analog-to-digital (A/D) converter 1 10 to convert the transmit signal 102 received from the down converter 105 into a digital signal. The detector 100 may couple the analog-to-digital converter 110 to a despreader 115 and a selector 120. Finally, the despreader 115 and the selector 120 cooperate to select the pilot channel from the signal provided by the A/D converter 110.

The down converter 105 may be coupled to a device input of the detector 100 to feed at least one of a radio frequency (RF) signal, an intermediate frequency (IF) signal or a base-band signal to the A/D converter 110. The despreader 115 may choose one or more despreading codes, according to the types of signals selected by the down converter 105, to despread the digital signal. To this end, the detector 100 may comprise a memory 125 that stores one or more despreading codes 130 in accordance with one embodiment of the present invention. In one embodiment, a programming interface may be used to provide a despreading code to the detector 100.

The detector 100 may further comprise a calculator 135 that may be used to determine a desired channel power of the pilot channel, which may be used to control the output power of the BTS, in accordance with one embodiment of the present invention. The calculator 135 may be coupled to a digital-to-analog (D/A) converter 140 in the detector 100 to deliver an analog signal at an output terminal of the detector 100 that is proportioned to a code domain power of the pilot channel, in one embodiment. The code domain power quantifies a base station's response to instructions from a wireless network, such as a digital cellular network. In a CDMA system, for example, because the user transmissions are isolated from one another by their unique individual codes, the power in each of the codes is expressed in decibels (dBs) relative to the total transmitter power in a channel. The code domain power of the pilot channel may be determined by the detector 100 using a combination of a pilot channel, a sync channel, a paging channel and six traffic channels.

In operation, the detector 100 may obtain an indication that is proportional to the channel power of the pilot channel of the transmit signal 102. The detector 100 may use the indication for controlling a control loop in the transmitter, and maintaining a desired level of an output power of the BTS. In one embodiment, the transmit signal 102 may be a non-constant spread spectrum signal that may be modulated in a relatively fast time varying manner defined at least in part by a Third Generation (3G) mobile communication standard. The calculator 135, in one embodiment, may derive an analog signal that is proportional to a code domain power of the pilot channel. Alternatively, the calculator 135 may derive a digital number that is proportional to a code domain power of the pilot channel.

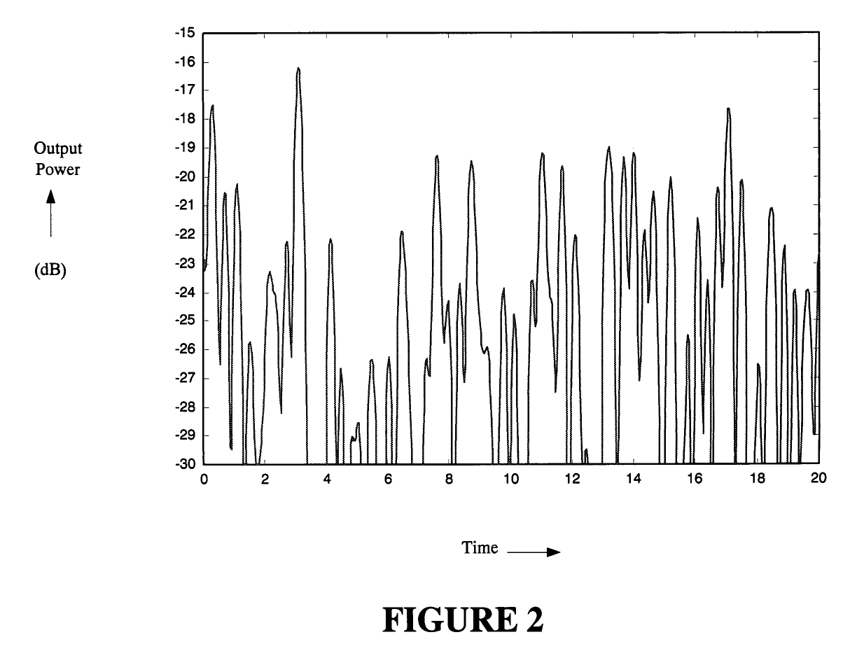

Referring to FIG. 2, a non-constant spread spectrum signal from a transmitter, such as a BTS in a cellular network, is depicted in accordance with one illustrative embodiment of the present invention. The output power (dB) over time (measured in chip duration) is shown for the non-constant spread spectrum signal, i.e., an output or transmit signal from a transmitter. More specifically, the non-constant spread spectrum signal shown in FIG. 2 depicts a peak-to-average ratio of 10 dB for the output or transmit signal from a transmitter.

Using the detector 100, a transmitter may measure the power of a non-constant power envelope of the non-constant spread spectrum signal. That is, by analyzing the content of the non-constant spread spectrum signal, which may be a UMTS signal, the power of the pilot channel may be determined from the output signal of the transmitter of a communication node.

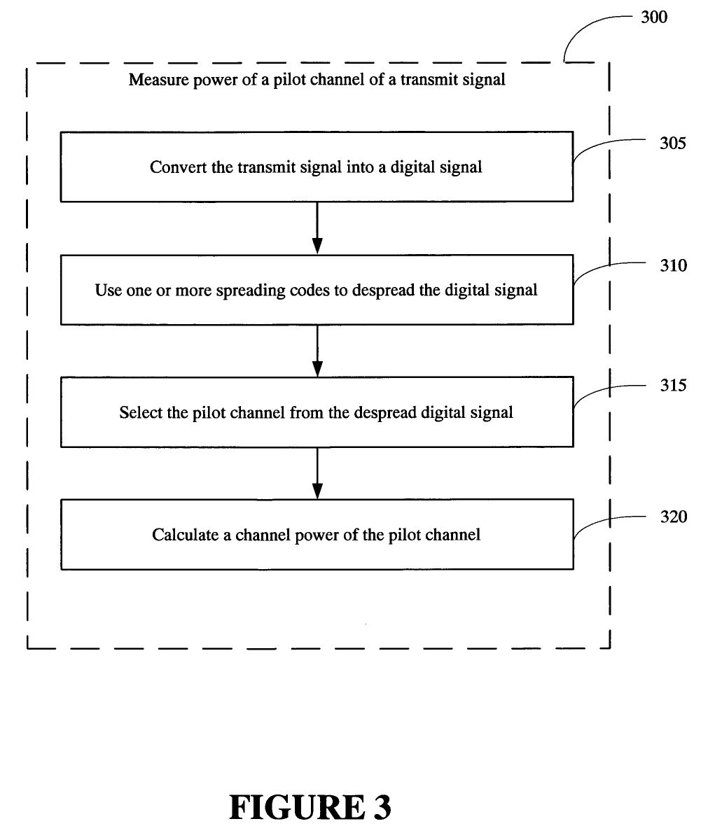

Referring to FIG. 3, a stylized representation of a flowchart that implements a method for measuring a channel power of a pilot channel of the transmit signal 102 is shown using the detector 100 according to one illustrative embodiment of the present invention. At block 300, the detector 100 (shown in FIG. 1) may measure the power of the pilot channel of the transmit signal 102, which may be a non-constant envelope spread spectrum signal, such as from a BTS operating under the 3G mobile communication standard using a Universal Mobile Telecommunications System (UMTS) protocol. That is, the detector 100 may measure only the pilot channel power of the transmit signal 102, and this measured power of the pilot channel may be used as an input signal to a closed power control loop controlling the output power from a transmitter of a BTS in a wireless network, such as a digital cellular network.

In one embodiment, the detector 100 may deliver a measure of the only traffic independent part of the transmit signal 102, i.e., the pilot channel code domain power. The code domain power of the pilot channel is independent of the amount of traffic and may also not be affected by the peak-to-average ratio of the transmit signal 102. In this manner, the detector 100 may deliver an analog signal or a digital number that is proportional to the code domain power of the pilot channel. This analog signal or the digital number may be used by a control loop to maintain an appropriate level of transmitter output power of a BTS, in one embodiment.

To this end, at block 305, the detector 100 may convert the transmit signal 102 into a digital signal. At block 310, using one or more spreading codes stored in the memory 125 (see in FIG. 1), the detector 100 may despread the digital signal. At block 315, the detector 100, using the selector 120, may select the pilot channel from the despread digital signal. Using the calculator 135, the detector 100, at block 320, may calculate a desired channel power of the pilot channel.

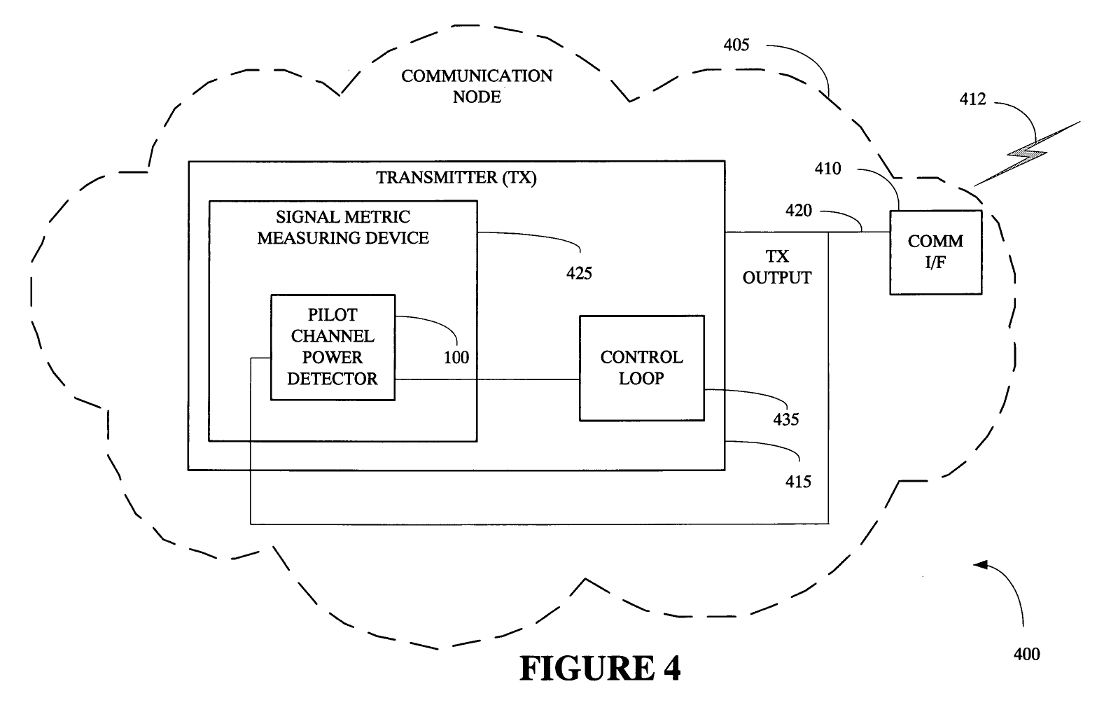

Referring to FIG. 4, a telecommunication system 400 is shown to include a communication node 405 (e.g., a BTS) associated with a wireless network, such as a digital cellular network in accordance with one illustrative embodiment of the present invention. The communication node 405 may communicate with a mobile device and includes a transmitter (TX) 415 for enabling communications with the mobile device over a wireless medium using a pilot channel. In one embodiment, the transmitter 415 may include the detector 100 to measure a channel power of the pilot channel of a transmitter output signal 420 from the transmitter 415.

The communication node 405 may comprise a communication interface (COMM I/F) 410 to communicate with a mobile device over a wireless medium 412 using a pilot channel within a service area according to one embodiment of the present invention. The transmitter 415 may further comprise a signal metric measuring device 425 which may include the detector 100 that controls a control loop 435 to control the output power from the transmitter 415. The signal metric measuring device 425, using the detector 100 and the control loop 435 may measure only a pilot channel output power of the transmitter 415 in the communication node 405, which may be a BTS transmitting spread spectrum signals

While the COMM I/F 410 may include a conventional radio frequency front end and an antenna system for mobile communications, the wireless medium 412 may be capable of handling mobile communication signals, such as cellular signals. For example, the wireless medium 412 may operate according to a code division multiple access (CDMA) standard or a Global System for Mobile Communications (GSM) standard, which is a land mobile pan-European digital cellular radio communications system.

In one embodiment, the service area of the telecommunication system 400 may be partitioned into connected service domains known as cells, where radio device users may communicate via radio frequency uplinks with the communication node 405, such as a BTS. The communication node 405 may be coupled to a wireless network in some embodiments of the present invention. The radio frequency uplink may involve a signal transmission from a mobile device to a BTS, forming a reverse communication link. A BTS (e.g., Node B) may be a piece of equipment used for communicating with the mobile devices and is coupled to a cell or a sector within a cell.

For the telecommunication system 400, e.g., a CDMA wireless mobile communication system, a pilot channel may be a special channel that a BTS at a cell transmits. In this way, the communication node 405 using the transmitter 415 may send or receive, voice, data, or a host of voice and data services in different—generation of wireless networks including digital cellular networks based on standards including Universal Mobile Telecommunications System (UMTS) and 3G-1X (Code Division Multiple Access) (CDMA) 2000), as well as IS-95 CDMA, Global System for Mobile Communication (GSM) and Time Division Multiple Access (TDMA).

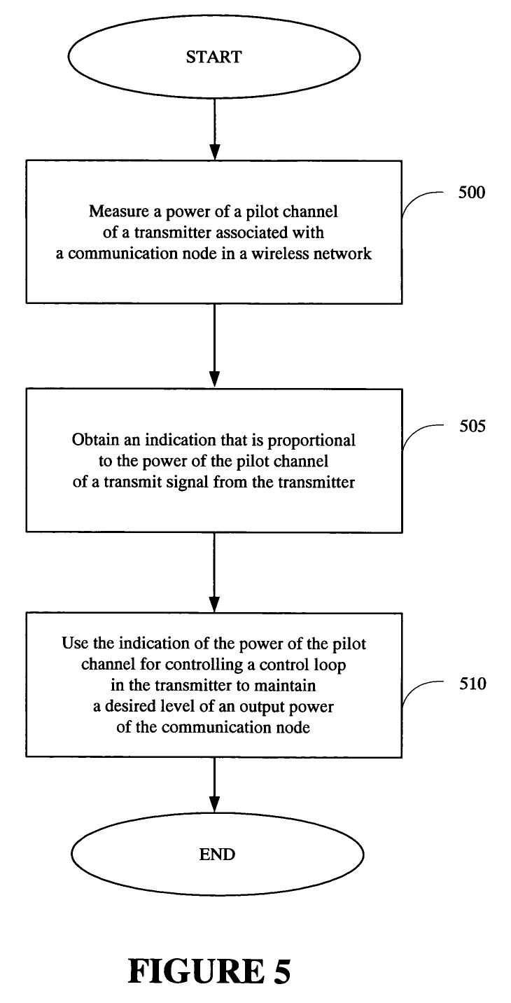

Referring to FIG. 5, a stylized representation of a flowchart implementing a method for measuring a channel power of a pilot channel of the transmitter output signal 420 from the transmitter 415 associated with the communication node 405 in the wireless network shown in FIG. 4 is depicted in accordance with one illustrative embodiment of the present invention. At block 500, the signal metric measuring device 425, using the detector 100, may measure the channel power of the pilot channel of the transmitter 415. At block 505, the signal metric measuring device 425 may obtain an indication that is proportional to the channel power of the pilot channel of the transmitter output signal 420 from the transmitter 415. Using that indication of the channel power of the pilot channel, at block 510, the signal metric measuring device 425 may control the control loop 435 in the transmitter 415, maintaining a desired level of output power of the communication node 405.

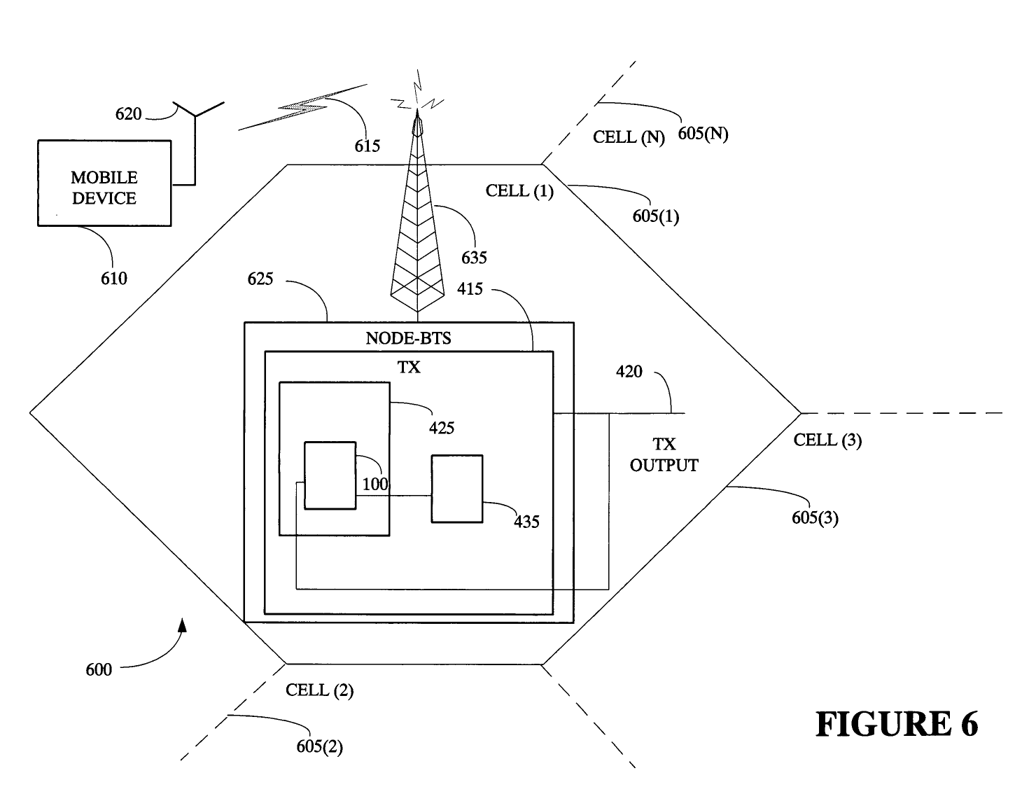

Referring to FIG. 6, a digital cellular network 600 covers a service area that may be partitioned into connected service domains shown as a plurality of cells 605(1-N), where a mobile device 610 user may communicate via a radio frequency link 615 using an antenna 620 with a node base transceiver station (NODE-BTS) 625 according to one illustrative embodiment of the present invention. The NODE-BTS 625 may comprise the transmitter 415 shown in FIG. 4. Using an antenna system 635, the NODE-BTS 625 may communicate with the mobile device 610 associated with the cell 605(1). That is, the cell 605(1) may be radiated by the antenna system 635 associated with the NODE-BTS 625 to communicate with the mobile device 610 within a cell coverage area.

Within the NODE-BTS 625, the transmitter 415 may receive a transmitter (TX) input signal and provide a transmitter output signal 420, such as a spread spectrum signal in accordance with one embodiment of the present invention. The spread spectrum signal may include the non-constant power envelop shown in FIG. 2 and, may be defined, at least in part, by a 3G Mobile Communication standard based on a Universal Mobile Telecommunications System protocol. From the transmitter output signal 420, the signal metric measuring device 425 may measure an output power of the non-constant power envelop in the transmitter output signal 420, in turn, deriving a measure of power for the cell 605(1) in the digital cellular network 600.

The transmitter 415 may set the measure of power for the cell 605(1) such that the output power from the NODE-BTS 625 covers a predetermined cell size. In this manner, the signal metric measuring device 425, using the detector 100 and control loop 435, may control a size of the cell 605(1) in the digital cellular network 600 based on a measure that is independent of traffic in a communication with the mobile device 610.

In some embodiments, a fast time variant signal like a CDMA or a Wideband-CDMA modulated signal may be handled such that the power of such a signal may be accurately determined using the detector 100 shown in FIG. 1. In this manner, an accurate value for the output power may be obtained, avoiding a long time averaging and use of random or pseudorandom data as modulation content.

While the invention has been illustrated herein as being useful in a telecommunications network environment, it also has application in other connected environments. For example, two or more of the devices described above may be coupled together via device-to-device connections, such as by hard cabling, radio frequency signals (e.g., 802.11(a), 802.11(b), 802.11(g), Bluetooth, or the like), infrared coupling, telephone lines and modems, or the like. The present invention may have application in any environment where two or more users are interconnected and capable of communicating with one another.

Those skilled in the art will appreciate that the various system layers, routines, or modules illustrated in the various embodiments herein may be executable control units. The control units may include a microprocessor, a microcontroller, a digital signal processor, a processor card (including one or more microprocessors or controllers), or other control or computing devices as well as executable instructions contained within one or more storage devices. The storage devices may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices. The instructions, when executed by a respective control unit, causes the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

We claim:

1. A device, comprising:
a detector that measures a power of a pilot channel of a transmit signal from a transmitter associated with a communication node in a wireless network; and
a control loop in said transmitter to maintain a desired level of an output power of said communication node based on the power of the pilot channel.

2. A device, as set forth in claim 1, further comprising:
an analog-to-digital converter to convert the transmit signal from said transmitter into a digital signal;
a despreader coupled to said analog-to-digital converter to despread the digital signal; and
a selector coupled to said despreader to select the pilot channel from the despread digital signal.

3. A device, as set forth in claim 1, wherein said detector is adapted to obtain an indication that is proportional to the power of the pilot channel of the transmit signal.

4. A device, as set forth in claim 3, wherein said detector is adapted to use the indication for controlling a control loop in said transmitter to maintain a desired level of an output power of said communication node.

5. A device, as set forth in claim 1, wherein said detector is adapted to deliver an analog signal that is proportional to a code domain power of the pilot channel.

6. A device, as set forth in claim 1, wherein said detector is adapted to deliver a digital number that is proportional to a code domain power of the pilot channel.

7. A device, as set forth in claim 1, wherein the wireless network is a digital cellular network including a plurality of cells to communicate with a mobile device over a wireless medium and said transmitter is a base station transmitter of a base transceiver station associated with at least one of said plurality of cells.

8. A device, as set forth in claim 2, further comprising:
a memory storing one or more despreading codes to despread the digital signal.

9. A device, as set forth in claim 2, further comprising:
a calculator to calculate a channel power of the pilot channel to control an output power of said communication node.

10. A device, as set forth in claim 2, wherein said transmit signal is a non-constant spread spectrum signal which is modulated in a relatively fast time variant manner defined at least in part by a 3G mobile communication standard.

11. A device, as set forth in claim 2, further comprising:
a device input; and
a down converter coupled to said device input to feed at least one of a radio frequency signal, an intermediate frequency signal and a base-band signal.

12. A device, as set forth in claim 2, further comprising:
a programming interface to provide a despreading code.

13. A device, as set forth in claim 4, wherein said detector to derive a measure of power for a cell in the wireless network from a non-constant power envelop defined at least in part by a Universal Mobile Telecommunication System protocol.

14. A device, as set forth in claim 13, wherein said detector to set the measure of power for said cell in the wireless network such that said desired level of the output power of said communication node covers a cell size.

15. A device, as set forth in claim 13, wherein said detector to control a size of said cell in the wireless network based on a measure that is independent of traffic in a communication with a mobile device.

16. A method for measuring a power of a pilot channel of a transmitter associated with a communication node in a wireless network, the method comprising:
obtaining an indication that is proportional to the power of the pilot channel of a transmit signal from said transmitter; and
controlling a control loop in said transmitter to maintain a desired level of an output power of said communication node based on the indication of the power of the pilot channel.

17. A method, as set forth in claim 16, wherein obtaining an indication further comprising:
deriving a signal that is proportional to a code domain power of the pilot channel.

18. A method, as set forth in claim 16, wherein obtaining an indication further comprising:
deriving a digital number that is proportional to a code domain power of the pilot channel.

19. A method, as set forth in claim 16, further comprising:
despreading the transmit signal; and
selecting the pilot channel from the despread digital signal.

20. A method, as set forth in claim 19, wherein despreading the transmit signal further comprising:
storing one or more despreading codes; and
using said one or more despreading codes to despread the transmit signal.

21. A method, as set forth in claim 16, wherein measuring a power of a pilot channel further comprising:
calculating a channel power of the pilot channel to control the output power of said communication node.

22. A method, as set forth in claim 16, wherein measuring a power of a pilot channel further comprising:
detecting the power of the pilot channel from a non-constant spread spectrum signal, wherein the non-constant spread spectrum signal is a relatively fast time variant modulated signal defined at least in part by a 3G mobile communication standard.

23. A method, as set forth in claim 22, wherein detecting the power of the pilot channel, further comprising:
deriving a measure of power for a cell in the wireless network from a non constant power envelop defined at least in part by a Universal Mobile Telecommunication System protocol.

24. A method, as set forth in claim 23, further comprising:
setting the measure of power for said cell in the wireless network such that said desired level of the output power of said communication node covers a certain cell size.

25. A method, as set forth in claim 22, further comprising:
controlling a size of a cell in the wireless network based on a measure that is independent of traffic in a communication with a mobile device.

26. A telecommunication system, comprising:
a communication node associated with a wireless network, said communication node to communicate with a mobile device, wherein said communication node to include a transmitter for enabling mobile communications with said mobile device over a wireless medium using a pilot channel, said transmitter including:
a detector that measures a power of the pilot channel of a transmit signal from said transmitter associated with said communication node in the wireless network; and
a control loop to maintain a desired level of an output power of said communication node based on the power of the pilot channel.

27. A telecommunication system, as set forth in claim 25, wherein the wireless network is a digital cellular network including a plurality of cells to communicate with said mobile device over said wireless medium.

28. A telecommunication system, as set forth in claim 27, wherein said transmitter is a base station transmitter for a base transceiver station associated with at least one of said plurality of cells and the transmit signal is defined at least in part by a 3G mobile communication standard based on a Universal Mobile Telecommunication System protocol.
